(19) United States
(12) Patent Application Publication
(10) Pub. No.: US 2014/0247955 A1
(43) Pub. Date: Sep. 4, 2014

(54) FOLDED ELECTROSTATIC SPEAKER

(71) Applicant: SONY CORPORATION, Tokyo (JP)

(72) Inventor: Martin Nyström, Lund (SE)

(73) Assignee: SONY CORPORATION, Tokyo (JP)

(21) Appl. No.: 13/783,726

(22) Filed: Mar. 4, 2013

(51) Int. Cl. H04R 19/02

(52) U.S. Cl. CPC H04R 19/02
USPC 381/150; 29/825

(57) ABSTRACT

The invention is directed to a folded electrostatic speaker. An exemplary speaker comprises: a first membrane; a first electrode; a second membrane, at least a portion of the first membrane being connected to at least a portion of the second membrane; a second electrode; and a first opening defined between at least a portion of the first and second membranes for receiving and releasing air. At least a portion of the first membrane and at least a portion of the second membrane move substantially perpendicularly to at least a portion of the first opening. At least a portion of the first membrane moves towards at least a portion of the second membrane or away from at least a portion of the second membrane.

### BACKGROUND

A speaker may be designed based on a dynamic principle, a piezoelectric principle, or an electrostatic principle. There is a need to produce a high-quality speaker based on any one of these principles.

### BRIEF SUMMARY

Embodiments of the invention are directed to a folded electrostatic speaker. An exemplary speaker comprises: a first membrane; a first electrode, wherein the first electrode is substantially parallel to at least a portion of the first membrane; a second membrane, at least a portion of the first membrane being connected to at least a portion of the second membrane; a second electrode, wherein the second electrode is substantially parallel to the second membrane; a first opening defined between at least a portion of the first membrane and at least a portion of the second membrane for receiving and releasing air; wherein a first polarization voltage is applied between the first membrane and the first electrode; wherein a second polarization voltage is applied between the second membrane and the second electrode; wherein at least a portion of the first membrane and at least a portion of the second membrane move substantially perpendicularly to at least a portion of the first opening; and wherein at least a portion of the first membrane moves towards at least a portion of the second membrane or away from at least a portion of the second membrane.

In some embodiments, at least one of at least a portion of the first membrane or at least a portion of the second membrane is rotatable about at least a portion of the first opening.

In some embodiments, the first polarization voltage produces an attractive or repulsive force between at least a portion of the first membrane and the first electrode.

In some embodiments, the first polarization voltage comprises a static polarization voltage, and wherein the attractive or repulsive force comprises a static attractive or repulsive force.

In some embodiments, the speaker produces acoustic sound when at least a portion of the first membrane moves towards at least a portion of the second membrane or away from at least a portion of the second membrane.

In some embodiments, the acoustic sound is based on a dynamic audio signal.

In some embodiments, at least a portion of the first membrane moves towards at least a portion of the second membrane when air is released from at least a portion of the first opening, and wherein at least a portion of the first membrane moves away from at least a portion of the second membrane when air is received into at least a portion of the first opening.

In some embodiments, the speaker comprises an ear speaker.

In some embodiments, the speaker comprises a loud speaker.

In some embodiments, a distance between at least a portion of the first membrane and the first electrode is less than or equal to a predetermined distance.

In some embodiments, the first polarization voltage is the same as, less than, or greater than the second polarization voltage, and wherein the first polarization voltage is less than or equal to a predetermined voltage.

In some embodiments, the first polarization voltage is applied using an external voltage source.

In some embodiments, the first polarization voltage is applied using an electret.

In some embodiments, an area associated with at least one of a portion of the first membrane or at least a portion of the second membrane is greater than an area associated with at least a portion of the first opening.

In some embodiments, the speaker is packaged into an electrical package.

In some embodiments, a depth of the speaker is less than or equal to a wavelength associated with a frequency associated with sound produced from the speaker.

In some embodiments, the frequency comprises a maximum frequency.

In some embodiments, the speaker does not comprise a magnet.

In some embodiments, the speaker comprises at least one of a magnetometer or a compass.

In some embodiments, a method is provided for providing a folded electrostatic speaker. The method comprises: providing a first membrane; providing a first electrode, wherein the first electrode is substantially parallel to at least a portion of the first membrane; providing a second membrane; connecting at least a portion of the first membrane to at least a portion of the second membrane; providing a second electrode, wherein the second electrode is substantially parallel to at least a portion of the second membrane; applying a first polarization voltage between the first membrane and the first electrode; applying a second polarization voltage between the second membrane and the second electrode, wherein a first opening is defined between at least a portion of the first membrane and at least a portion of the second membrane, wherein at least a portion of the first membrane and at least a portion of the second membrane move substantially perpendicularly to the first opening, and wherein at least a portion of the first membrane moves towards at least a portion of the second membrane or away from the second membrane.

### BRIEF DESCRIPTION OF THE DRAWINGS

Having thus described embodiments of the invention in general terms, reference will now be made to the accompanying drawings, where:

FIG. 1 is an exemplary folded electrostatic speaker element, in accordance with embodiments of the present invention; and

FIG. 2 is an exemplary process flow associated with constructing a folded electrostatic speaker element, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

The present invention is directed to a folded electrostatic speaker. The speaker may either be an ear speaker (e.g., a micro speaker that needs to be placed proximate an ear) or a general purpose speaker (e.g., a loud speaker that does not need to be placed proximate an ear). In some embodiments, the speaker may be part of a mobile device (e.g., a portable music player, a computing device, a mobile computing device such as a mobile phone, etc.). As used herein, a speaker may also be referred to as an element or a speaker element.

There are several principles for designing an ear speaker. A first principle is the dynamic principle. An ear speaker based on this principle includes a coil in a magnetic gap, where the coil is mechanically connected to a membrane. As used herein, a membrane is a thin layer that is used to produce or transfer sound. Varying the current that flows through the coil produces mechanical forces that shake the membrane thereby emitting a sound. A second principle is based on piezoelectric materials. Here, a voltage applied across a piezoelectric element changes the shape of the piezoelectric element thereby emitting a sound.

Another principle for designing an ear speaker is the electrostatic principle. For example, a membrane may be placed between two electrodes. A polarization voltage and an audio signal voltage are applied to the construction such that an attractive force is developed between the membrane and one of the two electrodes, and, simultaneously, a repulsive force is developed between the membrane and the other electrode. In another example, electrodes are stacked behind each other. By stacking the electrodes behind each other, membranes associated with the electrodes move in parallel along the same axis as an opening between the membranes. This enables an increase in speaker efficiency and also enables a larger distance between each electrode and membrane thereby allowing larger excursion levels. As used herein, excursion refers to the distance (e.g., linear distance) traveled by the membrane from its resting position.

In an embodiment of the present invention, a voltage is applied between a conducting membrane and at least one electrode positioned substantially in parallel to the conducting membrane. The applied voltage produces attractive and repulsive forces between the conducting membrane and the at least one electrode resulting in a sound being produced by the movement of the membrane. There are several advantages with using the electrostatic principle in designing the speaker. The speaker has a low moving mass (e.g., less than or equal to a predetermined threshold mass). Additionally, the speaker does not include a magnet, thereby allowing a magnetometer and compass to be mounted in the speaker. These advantages are not possible in a speaker based on any dynamic principle.

There are some challenges with designing a speaker based on the electrostatic principle. For example, a short distance between the membrane and the electrode produces a large force between a membrane and an electrode (e.g., attractive or repulsive force) but low maximum excursion. As used herein, excursion refers to the distance (e.g., linear distance) traveled by the membrane from its resting position. Additionally, a large distance between the membrane and the electrode produces a low force but high excursion. Additionally, when large forces are required at large distances between the membrane and the electrode, a high polarization voltage is required. Therefore, in order to achieve a required sound pressure level, there is a need for a large area (e.g., surface area associated with at least one of the membrane or electrode) and/or high excursion. The present invention overcomes the challenges associated with designing a speaker based on the electrostatic principle.

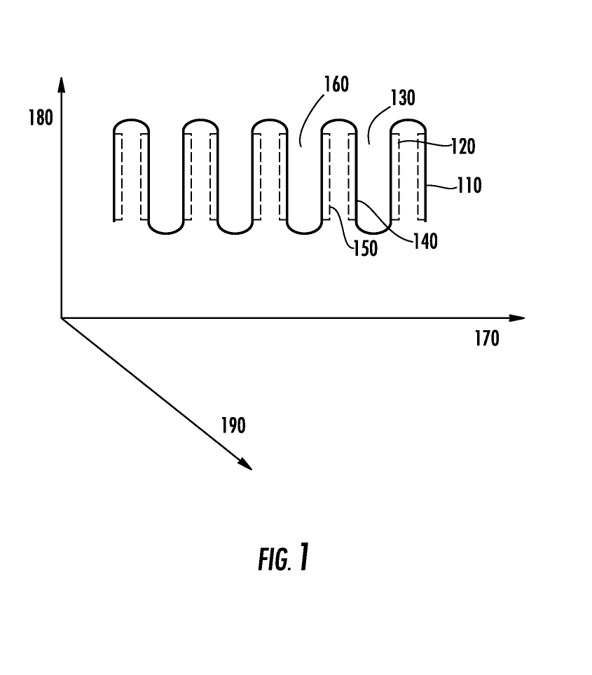

In some embodiments, an electrostatic speaker element is provided. An exemplary electrostatic speaker element 100 is illustrated in FIG. 1. The element comprises a first membrane 110, a first electrode 120, a first opening 130, a second membrane 140, a second electrode 150, and a second opening 160. The x-axis 170, y-axis 180, and z-axis 190 are also illustrated in FIG. 1. The opening (e.g., the first opening 130) may comprise an air opening such that air is either received into or released from the element 100. In an embodiment of the present invention, a voltage is applied between a membrane (e.g., the first membrane 110) and at least one electrode (e.g., first electrode 120) that is substantially parallel to the membrane. The applied voltage produces attractive and repulsive forces between the membrane and the at least one electrode resulting in a sound being produced by the movement of the membrane.

As used herein a first membrane 110 may refer to at least a portion (e.g., an edge, a corner, a surface, a point on the surface, or the like) of the first membrane 110, a second membrane 140 may refer to at least a portion (e.g., an edge, a corner, a surface, a point on the surface, or the like) of the second membrane 140, and a first opening 130 may refer to a portion of the first opening 130 that is defined by the first membrane 110 and the second membrane 140. At least a portion of the first membrane 110 is connected to at least a portion of the second membrane 140. Therefore, the first membrane 110 and the second membrane 140 may be connected at at least a point, an edge, or a surface.

The element 110 is foldable. This means that the first membrane 110 and the second membrane 120 can move or rotate in a substantially perpendicular manner about (e.g., around) the opening 130. Therefore, the first membrane 110 and the second membrane 120 may be able to rotate up to three hundred and sixty degrees about the opening 130. Therefore, the first membrane 110 may be folded onto the second membrane 120. By folding the membranes (and electrodes) onto each other, the radiating surface (e.g., the surface associated with one or more membranes) associated with the element can be maximized when the element is packaged into a small electrical package (e.g., a package that has a depth less than or equal to a predetermined depth). As an example, the first membrane 110 and the second membrane 120 rotate substantially perpendicularly about the opening 130 about the z-axis. By folding the membranes onto each other, the invention enables an increase in the total membrane surface area, thereby improving the quality of sound produced by the element.

As indicated in FIG. 1, the element comprises multiple membranes. The multiple membranes move towards each other in pairs (e.g., rotate about the opening between the multiple membranes) to squeeze air out of an opening, and away from each other in pairs to squeeze air into an opening. Although not illustrated as such in FIG. 1, the radiating area (e.g., the surface area of the first membrane 110 or the second membrane 120, the combined surface area of both the first membrane 110 and the second membrane 120, etc.) is larger than the area of the opening 130. The distance between the membrane (e.g., the first membrane 110) and the electrode (e.g., the first electrode 120) is small (e.g., less than or equal to a predetermined distance), thereby allowing for high attractive and repulsive forces (e.g., equal to or greater than a predetermined threshold force) at low polarization voltages (e.g., less than or equal to a predetermined polarization voltage). In some embodiments, the polarization voltage is applied to the electrodes using an external voltage source. In other embodiments, the polarization voltage is introduced into the electrodes using electrets. An electret is a dielectric material that has a quasi-permanent electric charge. The polarization voltage applied to the first electrode 120 is either less than, equal to, or greater than the polarization voltage applied to the second electrode 150. Either the same or a different voltage source or electret applies the polarization voltage to the first electrode 120 and the second electrode 150. The polarization voltage applied to the membrane comprises a static polarization voltage that produces static forces (e.g., attractive and/or repulsive forces between the membrane and the electrode). This static polarization voltage is separate from the audio signal voltage (e.g., dynamic audio signal voltage) applied to the membrane that results in an acoustic sound being generated by the element described herein.

In some embodiments, the depth of the electrostatic speaker element is less than or equal to one wavelength of the highest audio frequency that will be produced using the element. Therefore, the depth is in the order of a few decimeters (e.g., 1 dm) for a midrange audio (e.g., 0.3 to 5 kHz), and is in the order of a few millimeters for 20 kHz audio. 20 kHz audio is associated with a wavelength of about 17 mm (air, normal temperature). Therefore, a speaker can have a depth in the order of 10 mm and still have high efficiency at 20 kHz (e.g., an efficiency equal to or greater than a predetermined efficiency).

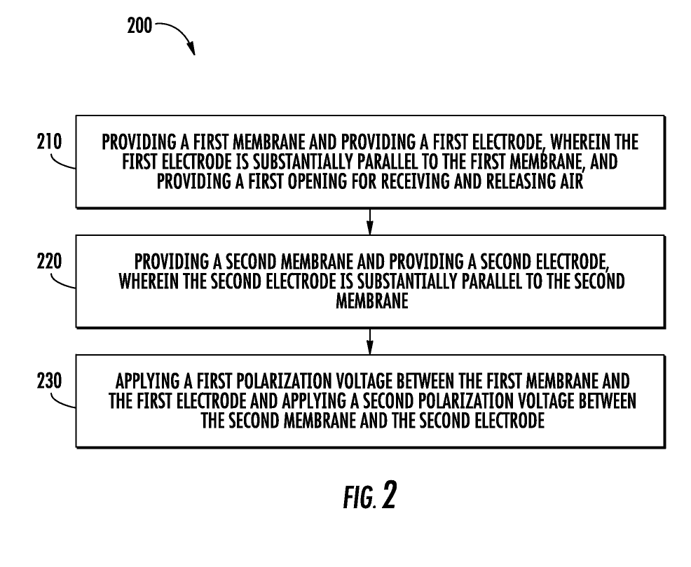

Referring now to FIG. 2, FIG. 2 presents a process flow 200 associated with a folded electrostatic ear speaker. The various process blocks presented in FIG. 2 may be executed in an order that is different from that presented in FIG. 2. At block 210, the process flow comprises providing a first membrane, and providing a first electrode, wherein the first electrode is substantially parallel to the first membrane, and providing a first opening for receiving and releasing air. At block 220, the process flow comprises providing a second membrane, and providing a second electrode, wherein the second electrode is substantially parallel to the second membrane. At block 230, the process flow comprises applying a first polarization voltage between the first membrane and the first electrode and applying a second polarization voltage between the second membrane and the second electrode.

In some embodiments, a computer program product may be provided for selecting various components of the electrostatic speaker element or for aiding in the construction of the electrostatic speaker element. The computer program product comprises a non-transitory computer-readable medium that comprises code configured to select various components of the electrostatic speaker element or to aid in construction of the electrostatic speaker element. As used herein, an element or speaker element may refer to a speaker, a construction, an apparatus, or a system.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A folded electrostatic speaker comprising:
a first membrane;
a first electrode, wherein the first electrode is substantially parallel to at least a portion of the first membrane;
a second membrane, at least a portion of the first membrane being connected to at least a portion of the second membrane;
a second electrode, wherein the second electrode is substantially parallel to the second membrane;
a first opening defined between at least a portion of the first membrane and at least a portion of the second membrane for receiving and releasing air;
wherein a first polarization voltage is applied between the first membrane and the first electrode;
wherein a second polarization voltage is applied between the second membrane and the second electrode;
wherein at least a portion of the first membrane and at least a portion of the second membrane move substantially perpendicularly to at least a portion of the first opening; and
wherein at least a portion of the first membrane moves towards at least a portion of the second membrane or away from at least a portion of the second membrane.

2. The speaker of claim 1, wherein at least one of at least a portion of the first membrane or at least a portion of the second membrane is rotatable about at least a portion of the first opening.

3. The speaker of claim 1, wherein the first polarization voltage produces an attractive or repulsive force between at least a portion of the first membrane and the first electrode.

4. The speaker of claim 3, wherein the first polarization voltage comprises a static polarization voltage, and wherein the attractive or repulsive force comprises a static attractive or repulsive force.

5. The speaker of claim 1, wherein the speaker produces acoustic sound when at least a portion of the first membrane moves towards at least a portion of the second membrane or away from at least a portion of the second membrane.

6. The speaker of claim 5, wherein the acoustic sound is based on a dynamic audio signal.

7. The speaker of claim 1, wherein at least a portion of the first membrane moves towards at least a portion of the second membrane when air is released from at least a portion of the first opening, and wherein at least a portion of the first membrane moves away from at least a portion of the second membrane when air is received into at least a portion of the first opening.

8. The speaker of claim 1, wherein the speaker comprises an ear speaker.

9. The speaker of claim 1, wherein the speaker comprises a loud speaker.

10. The speaker of claim 1, wherein a distance between at least a portion of the first membrane and the first electrode is less than or equal to a predetermined distance.

11. The speaker of claim 1, wherein the first polarization voltage is the same as, less than, or greater than the second polarization voltage, and wherein the first polarization voltage is less than or equal to a predetermined voltage.

12. The speaker of claim 1, wherein the first polarization voltage is applied using an external voltage source.

13. The speaker of claim 1, wherein the first polarization voltage is applied using an electret.

14. The speaker of claim 1, wherein an area associated with at least one of a portion of the first membrane or at least a portion of the second membrane is greater than an area associated with at least a portion of the first opening.

15. The speaker of claim 1, wherein the speaker is packaged into an electrical package.

16. The speaker of claim 1, wherein a depth of the speaker is less than or equal to a wavelength associated with a frequency associated with sound produced from the speaker.

17. The speaker of claim 16, wherein the frequency comprises a maximum frequency.

18. The speaker of claim 1, wherein the speaker does not comprise a magnet.

19. The speaker of claim 1, wherein the speaker comprises at least one of a magnetometer or a compass.

20. A method for providing a folded electrostatic speaker, the method comprising:
providing a first membrane;
providing a first electrode, wherein the first electrode is substantially parallel to at least a portion of the first membrane;
providing a second membrane;
connecting at least a portion of the first membrane to at least a portion of the second membrane;
providing a second electrode, wherein the second electrode is substantially parallel to at least a portion of the second membrane;
applying a first polarization voltage between the first membrane and the first electrode;
applying a second polarization voltage between the second membrane and the second electrode,
wherein a first opening is defined between at least a portion of the first membrane and at least a portion of the second membrane,
wherein at least a portion of the first membrane and at least a portion of the second membrane move substantially perpendicularly to the first opening, and
wherein at least a portion of the first membrane moves towards at least a portion of the second membrane or away from the second membrane.
